(19) United States
(12) Patent Application Publication
(10) Pub. No.: US 2013/0219814 A1
(43) Pub. Date: Aug. 29, 2013

(54) WINDOW BUCK HAVING RIGHT TRAPEZOID CROSS-SECTION

(71) Applicant: Gary C. Piccirillo, Tequesta, FL (US)

(72) Inventor: Gary C. Piccirillo, Tequesta, FL (US)

(21) Appl. No.: 13/408,329

(22) Filed: Feb. 29, 2012

(51) Int. Cl. E06B 1/36; E06B 1/04; B32B 23/02

(52) U.S. Cl. 52/215; 428/192; 52/745.16

(57) ABSTRACT

A window buck/drywall panel assembly comprising a window buck having a cross-section where the cross-section defines a right trapezoid, where the window buck includes a window buck beveled edge; and a drywall panel having a cross-section where the cross-section defines a right trapezoid, where the drywall panel includes a drywall beveled edge, and the window buck and the drywall panel are secured to one another such that the window buck beveled edge and the drywall beveled edge are in contact with one another.

### FIELD OF THE INVENTION

The invention broadly relates to window bucks, and, more particularly, to a window buck having a right trapezoid cross section.

### BACKGROUND OF THE INVENTION

In the construction industry, it is a standard practice to provide “roughed in” openings within the basic structural framing of a building for the installation of pre-fabricated window assemblies. A common technique used to install window assemblies within the roughed opening is known as “bucking” the window. This includes installing pieces of material known as “window bucks” inside the window opening to compensate for the difference between the width of the window opening and the dimensions of the window assembly. For proper window installation, the window bucks need to be placed a predetermined distance (known as the “setback distance”) from the outer edge of the window opening to provide uniform windowsills or “reveals.” Additionally, the window bucks should be aligned substantially parallel to the window opening so that the window assembly can be installed squarely with respect to the window opening.

As mentioned above, window bucks are well known in the construction industry and provide a surface on which to fixedly secure a window frame assembly to the rough concrete block opening. Traditional window bucks have a rectangular cross-section and have a squared front surface such that the top surface and the bottom surface are substantially perpendicular to, and each intersect, the front surface at 90 degree angles. An example of a prior art squared window buck is shown in FIG. 1, which illustrates a perspective view of window frame/window buck/drywall panel assembly 10 having window bucks 12a, 12b, 12c, and 12d, and window assembly 11, which includes window frame 14 and window 15. Window opening surfaces 18a, 18b, 18c, and 18d are formed when a window opening is cut into wall 16. Wall 16 is typically made of concrete or cinder blocks. Each window buck 12a, 12b, 12c, and 12d, is fixedly secured to a corresponding window opening surface 18a, 18b, 18c, and 18d, respectively via concrete fasteners, such as screws, nails, or the like.

Once the window assembly is installed, there is usually a bare space between the window opening surface and the installed window frame. When the adjacent interior walls are completed, using drywall panels, plaster, or other material, this bare space often appears as an unsightly transition gap between the window opening surface and the completed wall. Typically, this space is filled with some form of drywall or other material to cover this area and provide a consistent surface between the finished interior wall and the window frame. The installation of such material is generally referred to as “wrapping” the window.

As shown in FIGS. 1 and 2, wood blocks 17a, 17b are fixedly secured to wall 16 near the window opening. Wood block 17a is secured vertically and substantially perpendicular to wood block 17b, which is secured horizontally to wall 16. Then, metal angles 19a, 19b are “wrapped” around corresponding wood blocks 17a, 17b, respectively, such that metal angles 19a, 19b, each form an L-shape. After that, drywall panels 13a, 13b are each fixedly secured, and substantially parallel, to corresponding metal angles 19a, 19b, respectively, such that drywall panels 13a, 13b are in contact with and substantially perpendicular to window frame 14. Subsequently, drywall panel 13c is fixedly secured to wood blocks 17a, 17b such that drywall panel 13c is substantially perpendicular to drywall panels 13a, 13b.

A problem with prior window bucks is that since the drywall panel is typically fixedly secured to the surface of the window buck adjacent to the window frame, and in contact with the window frame, a portion of the window frame is obscured, which is not aesthetically appealing. Another problem with prior window bucks is that it is necessary to secure the window buck to a metal angle, which then must be secured to a wood block. Since additional materials, such as metal angles, need to be used, construction costs are increased. Additionally, a large space is formed between the drywall panel and the window opening surface, possibly compromising the integrity of the construction.

Thus, there is a long-felt need for a window buck that can be fixedly secured closer to the window opening surface while allowing the drywall panel to be secured in such a manner that the entire window frame is exposed, and therefore, more aesthetically appealing. There is also a long-felt need for a window buck to which drywall panels can be secured such that the drywall panels are in closer proximity with the window opening surface, which strengthens the integrity of the construction. Furthermore, there is also a long-felt need for a window buck to which drywall panels can be secured directly without the need for an intermediary metal angle, and thus, reducing overall construction costs.

### BRIEF SUMMARY OF THE INVENTION

The present invention broadly comprises a window buck having a cross-section where the cross-section defines a right trapezoid. In another embodiment, the present invention comprises a window buck/drywall panel assembly having a window buck and a drywall panel. The window buck has a cross-section where the cross-section defines a right trapezoid, and the window buck includes a window buck beveled edge. The drywall panel has a cross-section where the cross-section defines a right trapezoid and the drywall panel includes a drywall beveled edge. The window buck and the drywall panel are secured to one another such that the window buck beveled edge and the drywall beveled edge are in contact with one another.

The window buck comprises a top surface, a bottom surface, a first side surface, and a second side surface. The second side surface and the bottom surface of the window buck are arranged at an acute angle θ to one another. The drywall panel comprises a top surface, a bottom surface, a first side surface, and a second side surface. Similar to the window buck, the second side surface and the bottom surface of the drywall panel are arranged at an acute angle σ to one another. Acute angle θ is in the range of approximately 30 degrees to 60 degrees, but preferably acute angle θ is approximately 45 degrees. Acute angle σ is in the range of approximately 30 degrees to 60 degrees, but preferably angle σ is approximately 45 degrees.

The bottom surface of the window buck further comprises a channel that is operatively arranged to receive caulking. Additionally, the window buck is operatively arranged to be securable about a concrete wall by any suitable means, such as screws, nails, adhesive, etc. Moreover, the window buck can be made of any suitable material such as composite material, polyvinyl carbonate, wood, plastic, etc.

The present invention comprises a method of installing a window in an opening in a dwelling, where the window includes a frame, and the opening is bounded by concrete or cinder blocks. The method comprises the following steps. First, a window buck having a cross-section, where the cross-section defines a right trapezoid and where the window buck includes a window buck beveled edge, is secured to the concrete or cinder blocks bounding the opening. Next, the window frame is secured to the window buck. After that, a drywall panel having a cross-section, where the cross-section defines a right trapezoid and where the drywall panel includes a drywall beveled edge, is secured to the window buck such that the window buck beveled edge and the drywall beveled edge are in contact with one another.

In yet another embodiment, the present invention comprises a window frame/window buck assembly, having a window assembly and a window buck assembly. The window assembly includes a window frame having four sides. The window buck assembly includes four window bucks. Each window buck has a cross-section, where the cross-section defines a right trapezoid, where each of the sides of the window frame is secured on one of the window bucks.

In yet another embodiment, the present invention comprises a window frame/window buck/drywall panel assembly, having a window assembly, a window buck assembly, and a drywall panel assembly. The window assembly includes a window frame having four sides. The window buck assembly includes four window bucks. Each window buck has a cross-section and each window buck includes a window buck beveled edge, where the cross-section defines a right trapezoid, where each of the sides of the window frame is secured to one of the window bucks. The drywall panel assembly includes four drywall panels. Each drywall panel has a cross-section, where the cross-section defines a right trapezoid and where the drywall panel includes a drywall beveled edge. The drywall panel assembly is secured to the window buck assembly such that a window buck beveled edge of each window buck is in contact with a drywall beveled edge of each drywall panel.

It is a general object of the present invention to provide a window buck and a drywall panel, both with a beveled edge. The beveled edges allow the window buck and the drywall panel to matingly engage one another when cut at the same angle. Additionally, the beveled edges allow the drywall panels to be fixedly secured such that the entire window frame is exposed, and therefore, is more aesthetically appealing. It is another object of the invention to provide a window buck to which drywall panels can be secured such that drywall panels are in closer proximity with the window opening surface, which strengthens the integrity of the construction. It is yet another object of the invention to provide a window buck to which drywall panels can be secured directly without the need for an intermediary metal angle, and thus, reducing overall construction costs.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a front perspective view of a typical prior art window frame/window buck assembly;

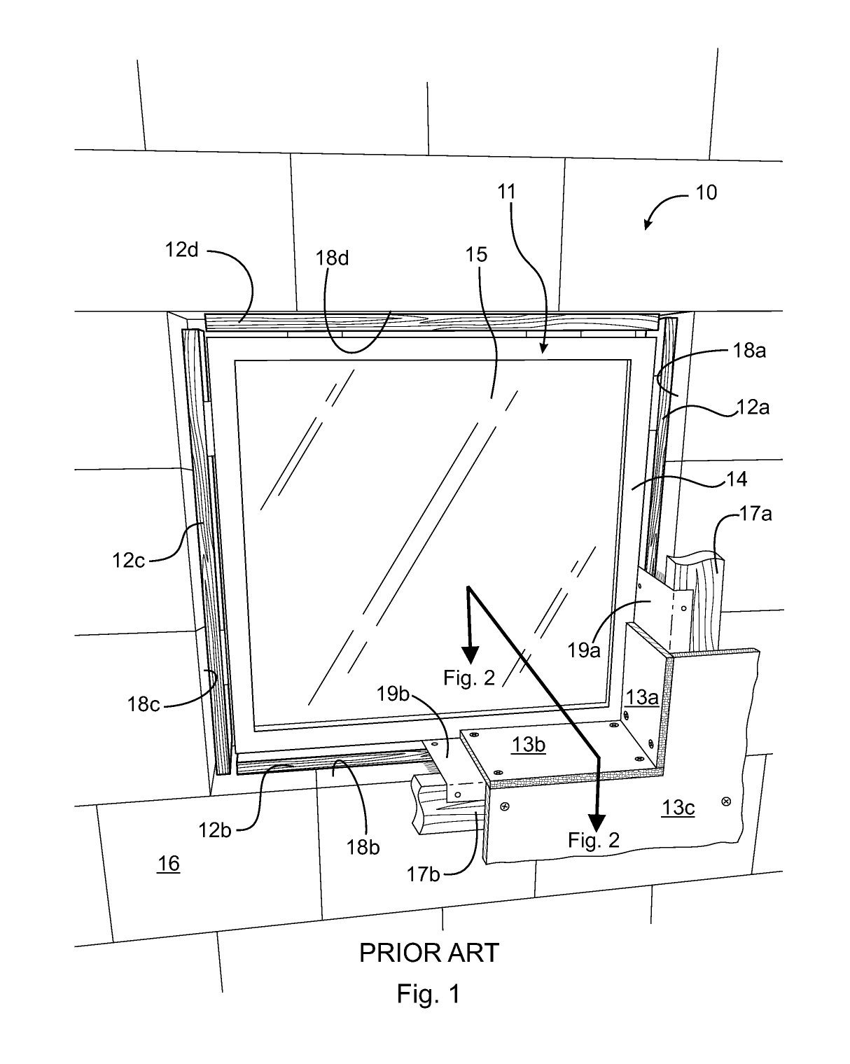

FIG. 2 is a cross-sectional view of the prior art window buck/drywall panel assembly taken generally along line 2-2 of FIG. 1;

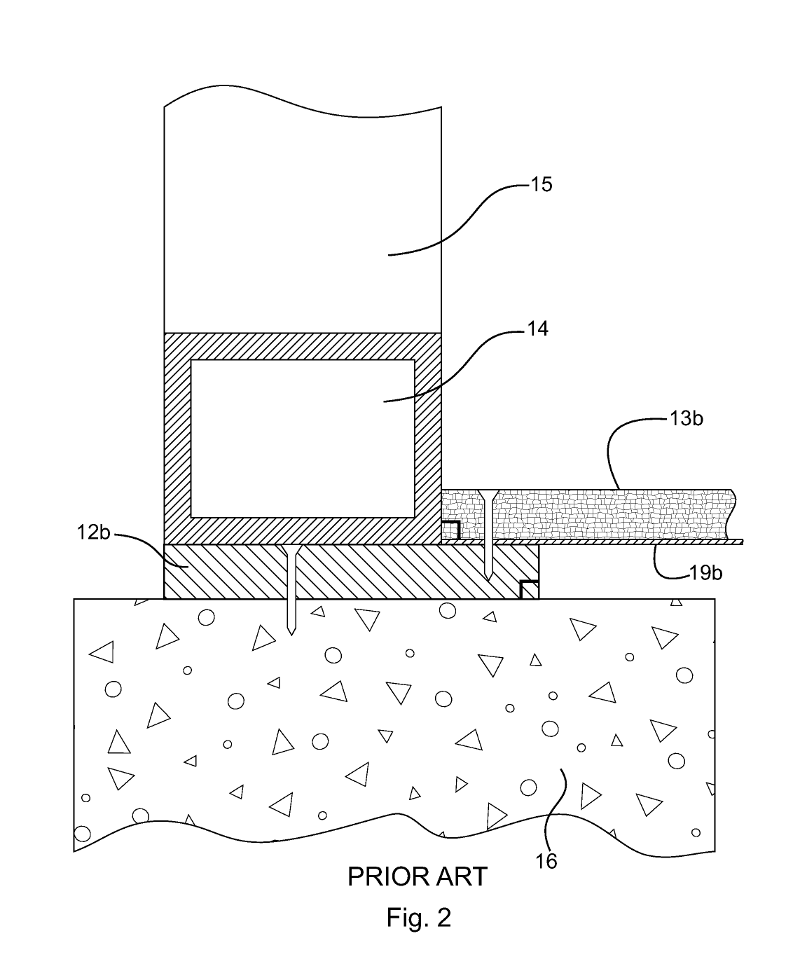

FIG. 3 is a front perspective view of the window frame/window buck assembly of the present invention;

FIG. 4 is a cross-sectional view of the window buck/drywall panel assembly taken generally along line 4-4 of FIG. 3;

FIG. 5 is a cross-sectional view of the window buck/drywall panel assembly taken generally along line 5-5 of FIG. 3;

FIG. 6 is a top perspective view of the window buck shown in FIG. 3; and,

FIG. 7 is a bottom perspective view of the window buck shown in FIG. 3.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention pertains. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. Although any methods, devices or materials similar or equivalent to those described herein can be used in the practice or testing of the invention, the preferred methods, devices, and materials are now described.

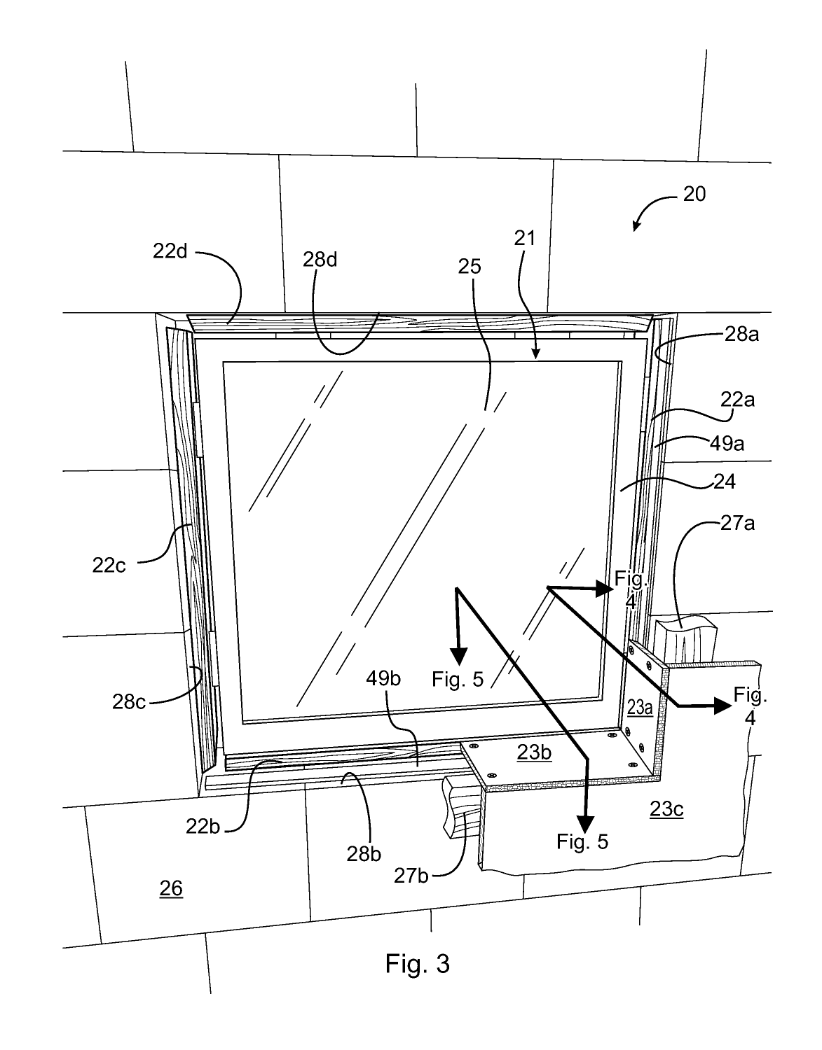

Adverting now to the figures, FIG. 3 illustrates the preferred embodiment of the present invention. FIG. 3 is a front perspective view of the window assembly of the present invention window frame/window buck/drywall panel assembly, hereinafter referred to as window buck assembly 20, shown housed within a window opening. Generally, window buck assembly 20 comprises four window bucks 22a, 22b, 22c, and 22d, and drywall panels 23a, 23b, 23c and window assembly 21, having window frame 24 and window 25.

Wall 16 includes four window opening surfaces 28a, 28b, 28c, and 28d. Each window buck 22a, 22b, 22c, and 22d, is fixedly secured to a corresponding window opening surface 28a, 28b, 28c, and 28d, respectively. Specifically, window buck 22a is arranged substantially vertically and fixedly secured to window opening surface 28a. Window buck 22a is disposed substantially perpendicular to window bucks 22b, 22d. Window buck 22b is arranged substantially horizontally and fixedly secured to window opening 28b. Window buck 22b is disposed substantially perpendicular to window bucks 22a, 22c. Window buck 22c is arranged substantially vertically and fixedly secured to window opening surface 28c. Window buck 22c is disposed substantially perpendicular to window bucks 22b, 22d. Window buck 22d is arranged substantially horizontally and fixedly secured to window opening surface 28d. Window buck 22d is disposed substantially perpendicular window bucks 22a, 22c. Window bucks 22a, 22b, 22c, and 22d are fixedly secured to corresponding window opening surfaces 28a, 28b, 28c, and 28d, respectively, via concrete screws. Although, it should be appreciated that the window bucks may be secured to the window opening surfaces by any suitable means, such as screws, nails, etc.

Although the window buck assembly includes four (4) window bucks and four (4) window opening surfaces, it should be apparent that window assemblies can vary in size and shape, and therefore, the number of window bucks and window opening surfaces may be fewer or greater depending on the size and shape of the window opening. Additionally, in a preferred embodiment, the window buck is made of a composite material. However, it should be appreciated that the window buck can be made of any suitable material, such as wood, polyvinyl carbonate, plastic, etc.

Wood blocks 27a, 27b are fixedly secured to wall 26 adjacent to the window opening. Wood block 27a is fixedly secured vertically to wall 16 and substantially perpendicular to wood block 27b, which is secured horizontally to wall 16. In a preferred embodiment, wood blocks 27a, 27b are secured via concrete screws. However, it should be appreciated that the wood block may be secured by any suitable means, such as screws, nails, etc. It should be appreciated that, in a preferred embodiment, wood blocks 27a, 27b are made of wood; however, wood blocks 27a, 27b may be made of any suitable material, such as wood, plastic, composite material, etc. Drywall panel 23a is cut on a bias and matingly engages window buck 22a, which is cut on the opposite bias. Similarly, drywall panel 23b matingly engages window buck 22b in substantially the same manner. In a preferred embodiment, drywall panels 23a, 23b are fixedly secured to window bucks 22a, 22b, respectively, via drywall screws, but may be secured by any suitable means.

Each drywall panel 23a, 23b is fixedly secured and substantially perpendicular to a corresponding wood block 27a, 27b, respectively. In a preferred embodiment, drywall panels 23a, 23b are fixedly secured to wood blocks 27a, 27b, respectively, via drywall screws, but may be secured by any suitable means. Preferably, furring strips 49a, 49b are fixedly secured to corresponding window opening surface 28a, 28b, respectively, via concrete screws in between window opening surfaces 28a, 28b, and drywall panels 23a, 23b, respectively. Drywall panel 23c is fixedly secured to wood blocks 27a, 27b such that drywall panel 23c is substantially perpendicular to drywall panels 23a, 23b. By securing the drywall panels as mentioned above, window frame 24 is completely visible.

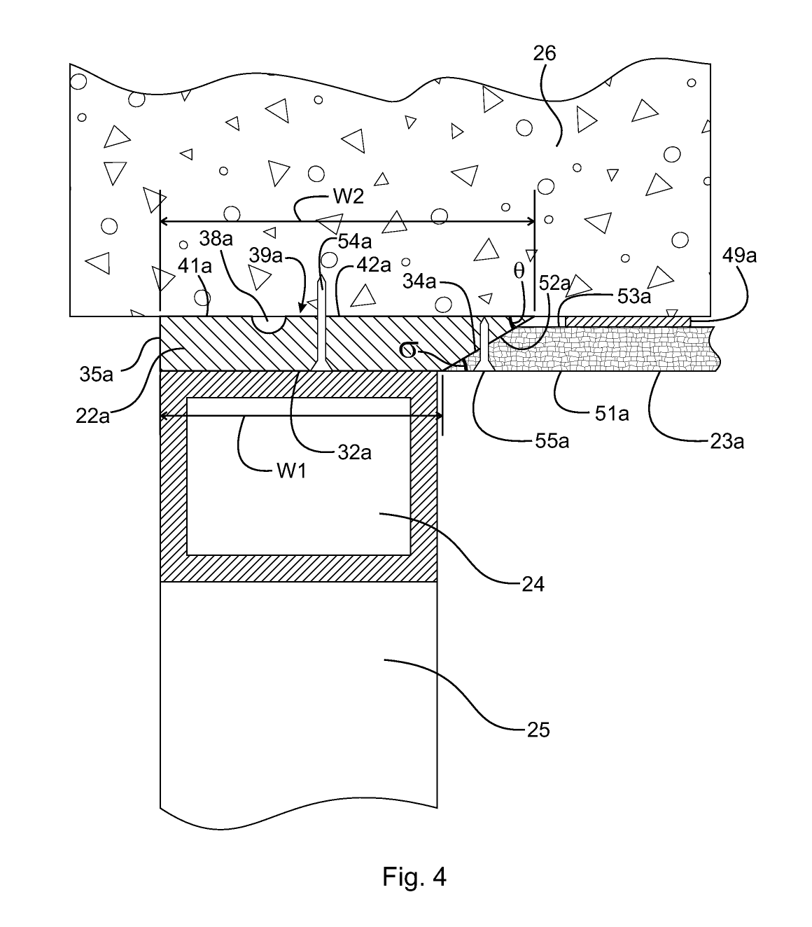

FIG. 4 is a cross-sectional view of window buck 22a and drywall panel 23a taken generally along line 4-4 of FIG. 3. Window buck 22a comprises top surface 32a, bottom surface 39a, first side surface 35a, and second side surface 34a. Concrete screw 54a is bored through top surface 32a of window buck 22a into wall 26 until the head of the screw is flush with top surface 32a in order to fixedly secure window buck 22a to window opening surface 28a. Drywall panel 23a comprises top surface 51a, bottom surface 53a, first side surface (not shown in FIG. 4) and second side surface 52a. Drywall screw 55a is bored through top surface 51a of drywall panel 23a into window buck 22a until the head of the screw is flush with top surface 51a in order to fixedly secure drywall panel 23a to window buck 22a. In a preferred embodiment, bottom surface 39a comprises first bottom surface 41a, second bottom surface 42a, and channel 38a. Channel 38a is recessed with bottom surface 39a and runs longitudinally along bottom surface 39a creating a division between first bottom surface 41a and second bottom surface 42a. Channel 38a is operatively arranged to receive caulking, or other adhesive material, as an additional means of securing the window buck to the window opening surface. Moreover, the caulking creates a watertight seal between the window buck and the window opening surface. It should be appreciated that the window buck and the drywall panel may be secured by any suitable means and manner.

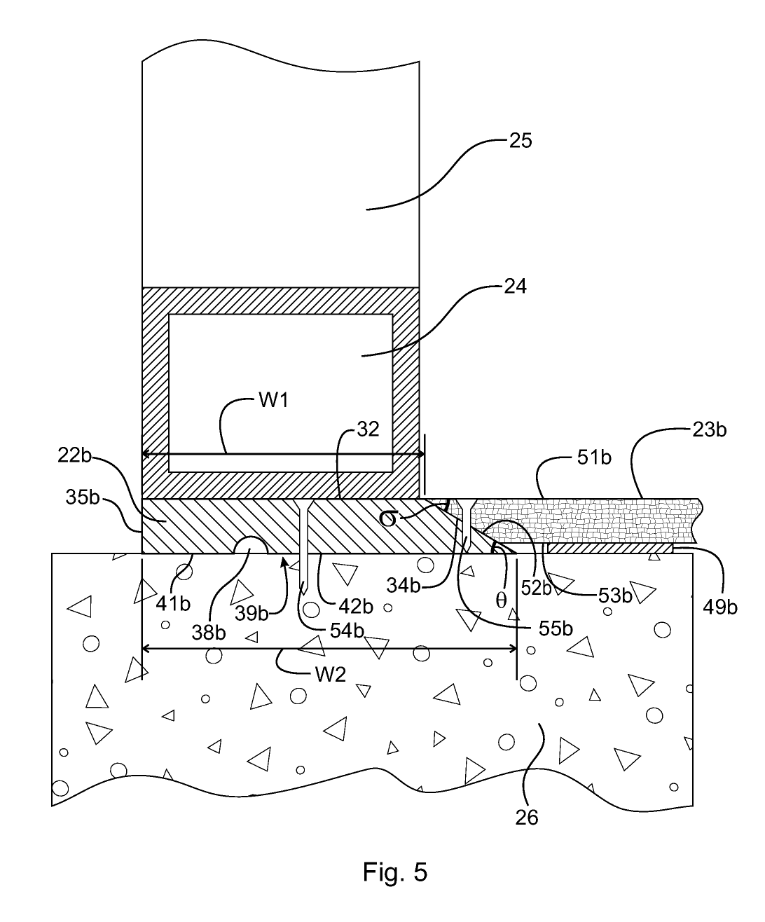

FIG. 5 is a cross-sectional view of window buck 22b and drywall panel 23b taken generally along line 5-5 of FIG. 3. Window buck 22b comprises top surface 32b, bottom surface 39b, first side surface 35b, and second side surface 34b. Concrete screw 54b is bored through top surface 32b of window buck 22b into wall 26 until the head of the screw is flush with top surface 32b in order to fixedly secure window buck 22b to window opening surface 28b. Drywall panel 23b comprises top surface 51b, bottom surface 53b, first side surface (not shown in FIG. 4) and second side surface 52b. Drywall screw 55b is bored through top surface 51b of drywall panel 23b into window buck 22b until the head of the screw is flush with top surface 51b in order to fixedly secure drywall panel 23b to window buck 22b. In a preferred embodiment, bottom surface 39b comprises first bottom surface 41b, second bottom surface 42b, and channel 38b. Channel 38b is recessed with bottom surface 39b and runs longitudinally along bottom surface 39b creating a division between first bottom surface 41b and second bottom surface 42b. Channel 38b is operatively arranged to receive caulking, or other adhesive material, as an additional means of securing the window buck to the window opening surface. As mentioned previously, the caulking also provides a watertight seal between the window buck and the window opening surface. It should be appreciated that the window buck and the drywall panel may be secured by any suitable means and manner.

As shown in FIGS. 4 and 5, the second side surface and the bottom surface of the window buck are arranged at acute angle θ to one another, forming a beveled edge. The second side surface and the bottom surface of the drywall panel are arranged at acute angle σ to one another, forming a beveled edge. In a preferred embodiment, angle θ and angle σ are identical, such that both angle θ and angle σ are 45 degrees. It should be appreciated, however, that the angles can vary depending on the configuration of the particular window buck/drywall panel assembly. Because both the window buck and the drywall panel are cut on a bias, second side surface 34a of window buck 22a matingly engages second side surface 52a of drywall panel 23a, such that entire window frame 24 is revealed. When second side surface 34a of window buck 22a matingly engages second side surface 52a of drywall panel 23a, top surface 32a of window buck 22a and top surface 51a of drywall panel 23a are flush with one another. Similarly, second side surface 34b of window buck 22b matingly engages second side surface 52b of drywall panel 23b, such that entire window frame 24 is revealed. In addition, when second side surface 34a of window buck 22a matingly engages second side surface 52a of drywall panel 23a, top surface 32a of window buck 22a and top surface 51a of drywall panel 23a are flush with one another.

Top surface 32a has top width W1 and bottom surface has a bottom width W2. Bottom surface 39a is substantially parallel to top surface 32a and top surface 32a and bottom surface 39a are coplanar. First side surface 35a is transverse and substantially perpendicular to top surface 32a and bottom surface 39a. Second side surface 34a is arranged opposite to first side surface 35a, such that second side surface 34a slopes downwardly from top surface 32a to bottom surface 39a. Therefore, top width W1 is smaller than bottom width W2.

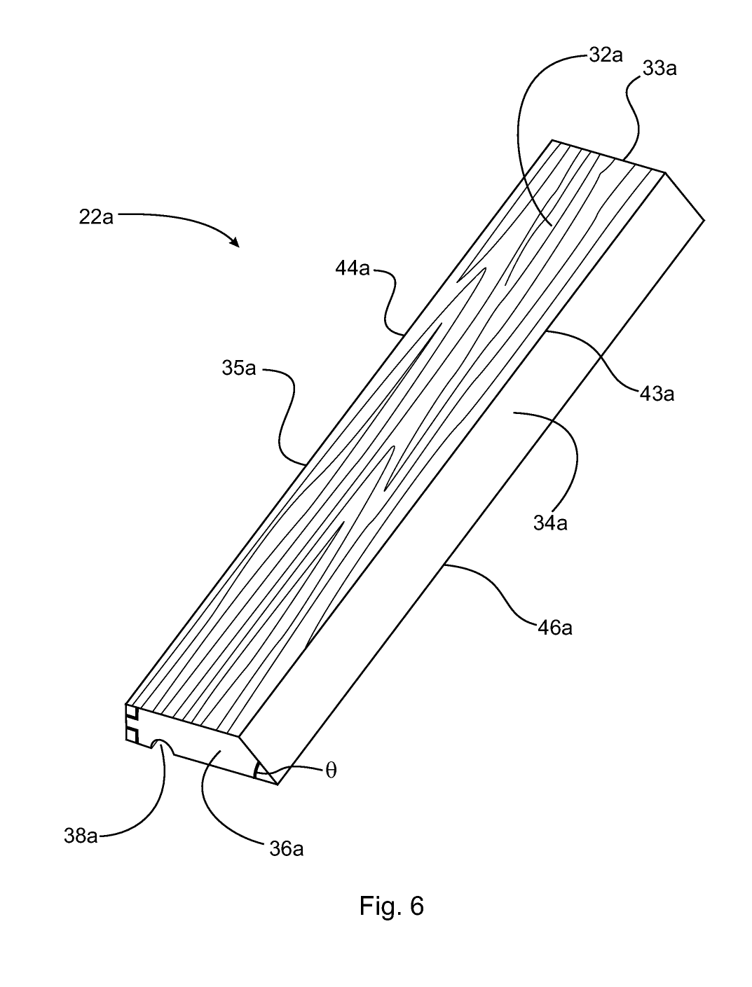

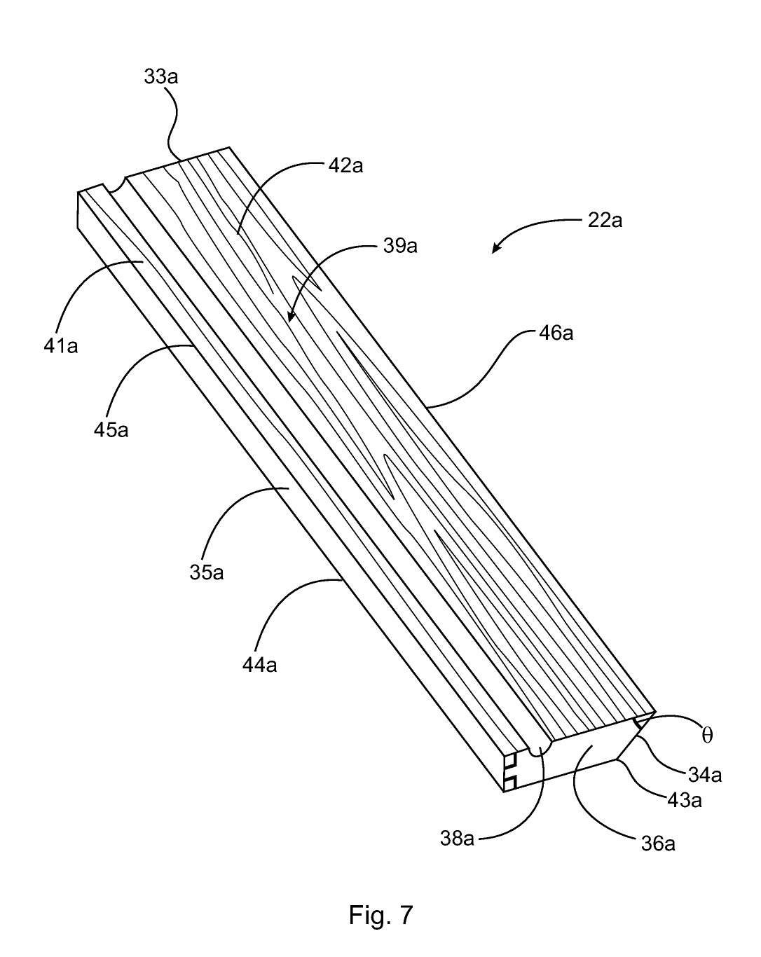

FIGS. 6 and 7 are perspective views of window buck 22a shown in FIG. 3. Window buck 22a comprises edges 43a, 44a, 45a, and 46a. Edge 43a is formed by the intersection of top surface 32a and second side surface 34a. Edge 44a is formed by the intersection of top surface 32a and first side surface 35a. Edge 45a is formed by the intersection of bottom surface 39a and first side surface 35a. Edge 46a is formed by the intersection of bottom surface 39a to second side surface 34a.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A window buck having a cross-section where said cross-section defines a right trapezoid.

2. The window buck recited in claim 2, wherein said window buck comprises a top surface, a bottom surface, a first side surface, and a second side surface, said second side surface and said bottom surface arranged at an acute angle θ to one another forming a beveled edge.

3. The window buck recited in claim 2, wherein said acute angle θ is in the range of approximately 30 degrees to approximately 60 degrees.

4. The window buck recited in claim 3, wherein said acute angle θ is approximately 45 degrees.

5. The window buck recited in claim 2, wherein said window buck is made of polyvinyl carbonate.

6. The window buck recited in claim 2, wherein said window buck is made of plastic.

7. The window buck recited in claim 2, wherein said window buck is made of wood.

8. The window buck recited in claim 2, wherein said window buck is made of a composite material.

9. The window buck recited in claim 2, wherein said bottom surface comprises a channel operatively arranged to receive caulking.

10. The window buck recited in claim 2, wherein said beveled window buck is operatively arranged to be securable to a window opening via screws.

11. The window buck recited in claim 2, wherein said window buck is operatively arranged to be securable to said window opening via nails.

12. The window buck recited in claim 2, wherein said top surface has a top width W1 and said bottom surface has a bottom width W2, and said bottom width W2 is greater than said top width.

13. A drywall panel having a cross-section where said cross-section defines a right trapezoid.

14. The drywall panel recited in claim 13, wherein said drywall panel comprises a top surface, a bottom surface, a first side surface, and a second side surface, said second side surface and said bottom surface arranged at an acute angle σ to one another forming a beveled edge.

15. The drywall panel recited in claim 14, wherein said acute angle σ is in the range of approximately 30 degrees to approximately 60 degrees.

16. The drywall panel recited in claim 15, wherein said acute angle σ is approximately 45 degrees.

17. A window buck/drywall panel assembly comprising:
a window buck having a cross-section where said cross-section defines a right trapezoid, wherein said window buck includes a window buck beveled edge; and,
a drywall panel having a cross-section where said cross-section defines a right trapezoid, wherein said drywall panel includes a drywall beveled edge; wherein said window buck and said drywall panel are secured to one another such that said window buck beveled edge and said drywall beveled edge are in contact with one another.

18. The window buck/drywall panel assembly recited in claim 17, wherein said window buck comprises a top surface, a bottom surface, a first side surface, and a second side surface, said second side surface and said bottom surface arranged at an acute angle θ to one another, and said drywall panel comprises a top surface, a bottom surface, a first side surface, and a second side surface, said second side surface and said bottom surface arranged at an acute angle σ to one another.

19. The window buck/drywall panel assembly recited in claim 18, wherein said acute angle θ is in the range of approximately 30 degrees to approximately 60 degrees, and said acute angle σ is in the range of approximately 30 degrees to approximately 60 degrees.

20. The window buck/drywall panel assembly recited in claim 19, wherein both said acute angle θ and said acute angle σ are approximately 45 degrees.

21. A method of installing a window in an opening in a dwelling, where said window includes a frame, and said opening is bounded by concrete or cinder blocks, said method comprising the following steps:
securing a window buck having a cross-section, where said cross-section defines a right trapezoid and wherein said window buck includes a window buck beveled edge, to said concrete or cinder blocks bounding said opening;
securing said window frame to said window buck; and,
securing a drywall panel having a cross-section, where said cross-section defines a right trapezoid and wherein said drywall panel includes a drywall beveled edge, to said window buck such that said window buck beveled edge and said drywall beveled edge are in contact with one another.

22. A window frame/window buck assembly, comprising:
a window assembly having a frame, said frame having four sides; and,
a window buck assembly having four window bucks, each window buck having a cross-section, where said cross-section defines a right trapezoid, where each of said sides of said window frame is secured on one of said window bucks.

23. A window frame/window buck/drywall panel assembly, comprising:
a window assembly having a frame, said frame having four sides;
a window buck assembly having four window bucks, each window buck having a cross-section and each window buck includes a window buck beveled edge, where said cross-section defines a right trapezoid, where each of said sides of said window frame is secured to one of said window bucks; and,
a drywall panel assembly having four drywall panels, each said drywall panel having a cross-section, where said cross-section defines a right trapezoid and wherein said drywall panel includes a drywall beveled edge, where said drywall panel assembly is secured to said window buck assembly such that a window buck beveled edge of each window buck is in contact with a drywall beveled edge of each drywall panel.
